(19) United States
(12) Patent Application Publication
(10) Pub. No.: US 2022/0213270 A1
(43) Pub. Date: Jul. 7, 2022

(54) POLY(ARYLENE SULFIDE) AND PROCESS FOR ITS MANUFACTURING

(71) Applicant: SOLVAY SPECIALTY POLYMERS USA, LLC, Alpharetta, GA (US)

(72) Inventors: Stéphane JEOL, Saint-Genis-Laval (FR); Hong CHEN, Alpharetta, GA (US); Brittany GILKENSON, Sandy Springs, GA (US); David B. THOMAS, Milton, GA (US); Philippe MARION, Vernaison (FR); Matthieu CORBET, Vourles (FR); Thomas GALEANDRO-DIAMANT, Villeurbanne (FR)

(21) Appl. No.: 17/605,259

(22) PCT Filed: Apr. 7, 2020
(86) PCT No.: PCT/EP2020/059939

§ 371 Date: Oct. 21, 2021

Related U.S. Application Data
(60) Provisional application No. 62/838,993, filed on Apr. 26, 2019.

(30) Foreign Application Priority Data
Jun. 19, 2019 (EP) 19178736.5

(51) Int. Cl. C08G 75/14; C08J 5/04

(52) U.S. Cl. CPC C08G 75/14; C08J 2381/04; C08J 5/042; C08J 5/043

(57) ABSTRACT

The present invention relates to a poly(arylene sulfide) (PAS), comprising recurring units p, q and r according of formula (I) wherein nₚ, n_{q} and nᵣ are respectively the mole % of each recurring units p, q and r; recurring units p, q and r are arranged in blocks, in alternation or randomly; 2≤(n_{q}+nᵣ)/(nₚ+n_{q}+nᵣ)≤9; n_{q} is ≥0% and nᵣ is ≥0%; j is zero or an integer varying between 1 and 4; R¹ is selected from the group consisting of halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups.

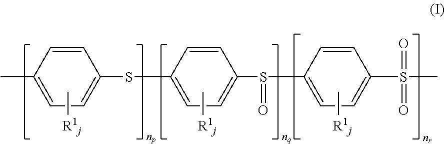

### CROSS REFERENCE TO RELATED APPLICATIONS

This application claims priority to U.S. provisional patent application No. 62/838,993, filed on 26 Apr. 2019 and European patent application No. 19178736.5, filed on 6 Jun. 2019, the whole content of these applications being incorporated herein by reference for all purposes.

### TECHNICAL FIELD

The present invention relates to a poly(arylene sulfide) (PAS) polymer and a process for its manufacturing, a polymeric composition comprising this poly(arylene sulfide) (PAS) and a method for its manufacturing, as well as an article, part or composite material comprising this poly(arylene sulfide) (PAS) or polymeric composition.

### BACKGROUND ART

Poly(arylene sulfide) (PAS) polymers are semi-crystalline thermoplastic polymers having notable mechanical properties, such as high tensile modulus and high tensile strength, and remarkable stability towards thermal degradation and chemical reactivity. They are also characterized by excellent melt processing, such as injection molding.

This broad range of properties makes PAS polymers suitable for a large number of applications, for example in the automotive, electrical, electronic, aerospace and appliances markets.

Despite the above advantages, PAS polymers are known to present a low impact resistance and a low elongation at break, in other words a poor ductility and a poor toughness.

Attempts have been made to solve this problem, notably by compounding PAS polymers with olefins and/or acrylate based elastomers, as for example described in US 2005/0089688, which discloses compositions comprising an olefinic polymer comprising ethylene and a glycidyl ester, an acidified PPS, and an elastomer comprising copolymers of ethylene and at least one of an (meth)acrylic acid. The resulting compounds however show a lower thermal stability and a significantly lower modulus than the PAS polymers themselves.

Other attempts involved decreasing the crystallinity of PAS polymers. According to EP 0 189 927, comonomers were introduced in the polymer chain. However, this approach implies that new molecules be introduced in the process and therefore the overall industrial process results to be modified from the synthesis to the recovery of the PAS and the recycling of solvents and unreacted monomers streams. According to another approach, for example described in U.S. Pat. No. 6,020,442, PAS polymers were oxidized into poly(arylene sulfoxide) and/or poly(arylene sulfone) polymers. However, such poly(arylene sulfoxide) and poly(arylene sulfone) polymers are mainly amorphous with poor chemical resistance. They exhibit a high glass transition temperature but lack of melt processing. Therefore, they are usually only used as additives for other polymers like PTFE.

Need is therefore felt to provide a PAS polymer having improved ductility and toughness, while maintaining high tensile strength, good chemical and temperature resistance and ease to be processed.

### SUMMARY OF INVENTION

In a first aspect, the present invention relates to a poly(arylene sulfide) (PAS), comprising recurring units p, q and r according of formula (I):

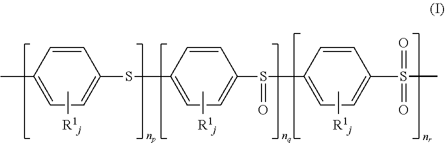

wherein

nₚ, n_{q} and nᵣ are respectively the mole % of each recurring units p, q and r;

recurring units p, q and r are arranged in blocks, in alternation or randomly;

2%≤(n_{q}+nᵣ)/(nₚ+n_{q}+nᵣ)≤9%;

n_{q} is ≥0% and nᵣ is ≥0%;

j is zero or an integer varying between 1 and 4;

R¹ is selected from the group consisting of halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups,

wherein the PAS has a heat of fusion of more than 20 J/g, determined on the 2^{nd} heat scan in differential scanning calorimeter (DSC) according to ASTM D3418, using heating and cooling rates of 20° C./min.

In a second aspect, the present invention relates to a process for manufacturing the poly(arylene sulfide) (PAS) of formula (I) as defined above, comprising a step of oxidizing solid particles of a poly(arylene sulfide) (PAS-p) comprising recurring units p in a liquid comprising an oxidizing agent.

In a third aspect, the present invention relates to a polymer composition (C), comprising:
the poly(arylene sulfide) (PAS) of formula (I) as defined above,
up to 65 wt. %, based on the total weight of the polymer composition, of an additional component selected from the group consisting of fillers, reinforcing agents, elastomers, colorants, dyes, pigments, lubricants, plasticizers, flame retardants, nucleating agents, heat stabilizers, light stabilizers, antioxidants, processing aids, fusing agents, electromagnetic absorbers and combinations thereof.

In a forth aspect, the present invention relates to a method for manufacturing the polymer composition (C) as defined above, comprising mixing said poly(arylene sulfide) (PAS) of formula (I) and said at least one additional component.

In a fifth aspect, the present invention relates to an article, part or composite material comprising the poly(arylene sulfide) (PAS) of formula (I) or the polymer composition (C) as defined above.

In a sixth aspect, the present invention relates to the use of said article, part or composite material in oil and gas applications, automotive applications, electric and electronic applications, aerospace and consumer goods.

The PAS of the invention shows increased ductility and elongation at break, while maintaining high tensile strength, good chemical and temperature resistance and good processability.

### DISCLOSURE OF THE INVENTION

In the present description, unless otherwise indicated, the following terms are to be meant as follows.

The expression “sulfide moiety” is intended to denote the —S— bridge of the recurring units p in formula (I).

The expression “sulfoxide moiety” is intended to denote the —SO— bridge of the recurring units q in formula (I).

The expression “sulfone moiety” is intended to denote the —SO₂— bridge of the recurring units r in formula (I).

The expression “oxidized moieties” is more general and is intended to denote both the sulfoxide moieties and the sulfone moieties.

Poly(Arylene Sulfide) (PAS)

The PAS of the present invention comprises recurring units p, q and r according of formula (I):

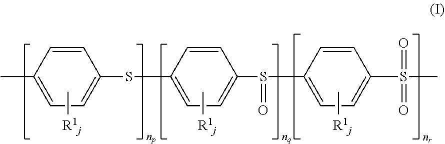

wherein the recurring units p, q and r are arranged in blocks, in alternation or randomly.

For the avoidance of doubts, recurring units p, q and r are represented respectively in formula (I) above from left to right.

In formula (I), j is zero or an integer varying between 1 and 4.

Preferably, j is zero in formula (I), which means that the aromatic ring is unsubstituted. Accordingly, recurring units p, q and r are, respectively, according to formulas (II), (Ill) and (IV) below:

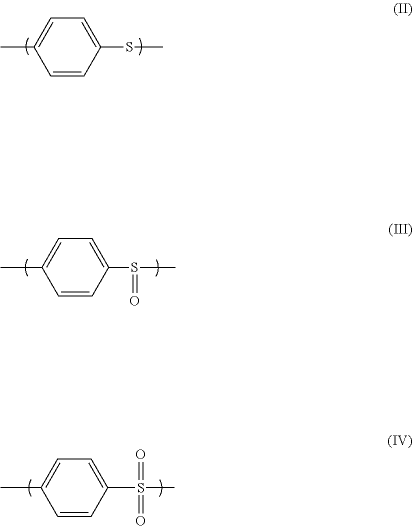

When j varies between 1 and 4, R¹ can be selected from the group consisting of halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups.

The molar percentage of recurring units p, q and r in formula (I), respectively noted nₚ, n_{q} and nᵣ, is such that 2%≤(n_{q}+nᵣ/(nₚ+n_{q}+nᵣ)≤9%, which means that the PAS polymer of formula (I) comprises between 2 and 9 mol. % of oxidized recurring units q and r, based on the total number of recurring units p, q and r in the polymer.

The PAS polymer of the invention comprises recurring units p, and it comprises recurring units q and/or r. When the PAS polymer comprises recurring units p, q and r, both n_{q} and nᵣ in the above equation are >0%. Alternatively, the PAS polymer of the invention may comprise recurring units p and q but no recurring units r. In this case n_{q} is ≥2%, but nᵣ=0%. According to a third possibility, the PAS polymer of the invention may comprise recurring units p and r but no recurring units q. In this case nᵣ is ≥2%, but n_{q}=0%.

In some embodiments, the molar percentage of recurring units p, q and r in formula (I) is such that:

2.2%≤(n_{q}+nᵣ)/(nₚ+n_{q}+nᵣ)≤8.8% or

2.5%≤(n_{q}+nᵣ)/(nₚ+n_{q}+nᵣ)≤8.5% or

2.8%≤(n_{q}+nᵣ)/(nₚ+n_{q}+nᵣ)≤8.2% or

3.0%≤(n_{q}+nᵣ)/(nₚ+n_{q}+nᵣ)≤7.0%

According to an embodiment of the invention, the sum nₚ+n_{q}+nᵣ is at least 50%, which means that the PAS comprises at least 50 mol. % of recurring units p, q and r, based on the total number of moles of recurring units in the PAS polymer. For example, the sum nₚ+n_{q}+nᵣ can be at least 60%, at least 70%, at least 80%, at least 90% or even at least 95%, based on the total number of moles of recurring units in the PAS polymer.

According to an embodiment of the invention, the PAS consists of, or consists essentially of, recurring units p, as well as recurring units q and/or r. The expression “consists essentially of” means that the PAS comprises recurring units p, and recurring units q and/or r, as well as less than 10 mol. %, preferably less than 5 mol. %, more preferably less than 3 mol. %, even more preferably less than 1 mol. %, of other recurring units distinct from recurring units p, q and r, based on the total number of moles of recurring units in the PAS polymer.

According to an embodiment, the PAS polymer of the present invention further comprises recurring units s and/or t, respectively, of formula (V) and/or (VI):

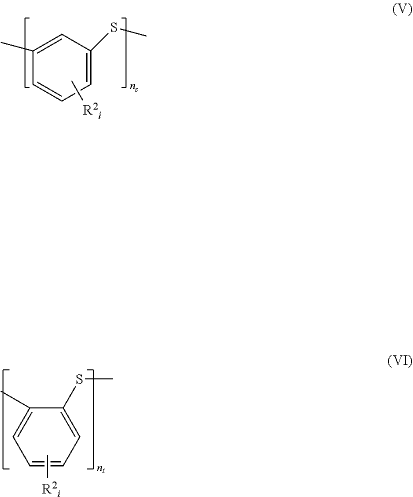

wherein:

i is zero or an integer varying between 1 and 4;

R² is selected from the group consisting of halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups.

In formulas (V) and (VI), i is preferably zero, which means that the aromatic rings are unsubstituted.

The sum nₛ+nₜ is less than 10 mol. %, preferably less than 5 mol. %, more preferably less than 3 mol. %, even more preferably less than 1 mol. %, based on the total number of moles of recurring units in the PAS polymer.

According to an embodiment, the sum nₚ+n_{q}+nᵣ is 100%, with at least one of n_{q} and nᵣ>0 mol. %.

According to an embodiment, the sum nₚ+n_{q}+nᵣ is less than 100%. In this embodiment, the PAS polymer comprises at least one recurring unit distinct from p, r and q, for example recurring units according to formulas (V) and/or (VI).

According to another embodiment, the sum nₚ+n_{q}+nᵣ+nₛ+nₜ is 100%, with at least one of n_{q} and nᵣ>0 mol. % and at least one of nₛ and nₜ>0 mol. %.

Preferably, the PAS has a melt flow rate (at 315.6° C. under a weight of 1.27 kg according to ASTM D1238, procedure B) of at most 700 g/10 min, more preferably of at most 500 g/10 min, even more preferably of at most 200 g/10 min, still more preferably of at most 50 g/10 min, yet more preferably of at most 35 g/10 min.

Preferably, the PAS has a melt flow rate (at 315.6° C. under a weight of 1.27 kg according to ASTM D1238, procedure B) of at least 1 g/10 min, more preferably of at least 5 g/10 min, even more preferably of at least 10 g/10 min, still more preferably of at least 15 g/10 min.

Preferably, the PAS has a melting point of at least 252° C., more preferably of at least 255° C., even more preferably of at least 260° C., when determined on the 2nd heat scan in differential scanning calorimeter (DSC) according to ASTM D3418, using heating and cooling rates of 20° C./min.

Preferably, the PAS has a melting point of at most 280° C., more preferably of at most 278° C., even more preferably of at most 275° C., when determined on the 2^{nd} heat scan in differential scanning calorimeter (DSC) according to ASTM D3418, using heating and cooling rates of 20° C./min.

Process for Manufacturing the PAS

Another object of the present invention is a process for manufacturing the PAS of formula (I), starting from a polymer comprising recurring units p (PAS-p), for example comprising from 50 mol. % to 100 mol. % of recurring units p (based on the total number of recurring units in the polymer).

The process comprises a step of oxidizing solid particles of a poly(arylene sulfide) (PAS-p) comprising recurring units p according to formula (VII):

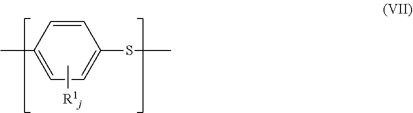

wherein:

j is zero or an integer varying between 1 and 4;

R¹ is selected from the group consisting of halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups,

wherein said step of oxidation takes place in a liquid containing an oxidizing agent.

The process of the invention advantageously does not comprise a step of solubilizing the solid particles of PAS-p when they are added to the liquid.

According to an embodiment, j is zero in formula (VII).

According to another embodiment, the PAS-p comprises at least 50 mol. % of recurring units p according to formula (VII), based on the total number of moles of recurring units in the polymer. For example, the PAS-p comprises at least 60 mol. %, at least 70 mol. %, at least 80 mol. %, at least 90 mol. %, at least 95 mol. % of recurring units p according to formula (VII), based on the total number of moles of recurring units in the polymer.

According to an embodiment of the invention, the PAS-p consists of, or consists essentially of, recurring units p. The expression “consists essentially of” means that the PAS-p comprises recurring units p and less than 10 mol. %, preferably less than 5 mol. %, more preferably less than 3 mol. %, even more preferably less than 1 mol. %, of other recurring units distinct from recurring units p, based on the total number of moles of recurring units in the PAS-p polymer.

According to an embodiment of the invention, the PAS-p comprises less than 10 mol. %, preferably less than 5 mol. %, more preferably less than 3 mol. %, even more preferably less than 1 mol. %, of recurring units distinct from recurring units p, based on the total number of moles of recurring units in the PAS-p polymer. The recurring units distinct from the recurring units p can be the same as the ones described above regarding the PAS polymer, namely recurring units s and/or t.

According to an embodiment, the PAS-p polymer is made exclusively of recurring units p.

According to another embodiment, the PAS-p polymer comprises at least one recurring unit distinct from p in an amount which is less than 5 mol. %, for example recurring units s and/or t.

Preferably, said liquid contains at least one of compound selected from the group consisting of an organic acid, an organic acid anhydride and a mineral acid. Examples of said organic acid are formic acid, acetic acid, trifluoroacetic acid, propionic acid, lactic acid, maleic acid and the like. Examples of said organic acid anhydride are acetic anhydride, trifluoroacetic anhydride, propionic anhydride, lactic anhydride, maleic anhydride, succinic anhydride, phthalic anhydride, benzoic anhydride, chlorobenzoic anhydride and the like. Examples of said mineral acid are nitric acid, sulphuric acid, hydrochloric acid, phosphoric acid and the like.

According to an embodiment of the invention, said oxidizing agent is hydrogen peroxide. Preferably, said oxidizing agent is an aqueous hydrogen peroxide solution.

According to another embodiment of the invention, said oxidizing agent is a peracid formed from a mixture of an aqueous hydrogen peroxide solution with an organic acid or an organic acid anhydride. Preferably, said peracid is a performic acid, a peracetic acid, a pertrifluoroacetic acid, a perpropionic acid, a perlactic acid, a perbenzoic acid or a per-m-chlorobenzoic acid.

According to a further embodiment of the invention, said oxidizing agent is an inorganic salt peroxide. As the inorganic salt peroxide, a persulfate salt, a perborate salt and a percarbonate salt are preferred. As the salt mentioned here, an alkali metal salt, an alkali earth metal salt, an ammonium salt are preferred. A sodium salt, a potassium salt and an ammonium salts are particularly preferred. Examples of inorganic salt peroxides are sodium persulfate, potassium persulfate, ammonium persulfate, sodium perborate, potassium perborate and ammonium perborate, sodium percarbonate, potassium percarbonate.

Said liquid advantageously contains the oxidizing agent in an amount such that from 2 to 9 mol. % of the sulfide moieties of the PAS-p are oxidized into sulfoxide moieties and/or sulfone moieties, thus providing the PAS according to the present invention. In this embodiment, said liquid advantageously contains the oxidizing agent in an amount from 2 to 9 mol. % of the sulfide moieties in the PAS-p polymer.

According to a preferred embodiment of the invention, said liquid contains acetic acid. According to a preferred embodiment, said oxidizing agent is hydrogen peroxide. According to a more preferred embodiment, said liquid contains a peracid formed by reaction of acetic acid and hydrogen peroxide.

The solid particles of PAS-p polymer may be added to the liquid in a broad range of concentration, for example from 5 wt. % or 10 wt. % up to 30 wt. % or even more, based on the total weight of the reaction mixture. Advantageously, the solid particles of PAS-p polymer are added to the liquid in a concentration higher than 20 wt. %, based on the total weight of the reaction mixture.

According to a preferred embodiment, the solid particles of PAS-p have all dimensions comprised between 0.001 mm and 10 mm, preferably between 0.01 mm and 5 mm. Preferably, the solid particles of PAS-p are powders formed after polymerization and recovery of the PAS-p according to know industrial processes.

Preferably, the solid particles of PAS-p used are directly obtained from the preparation process of PAS-p.

Preferably, said step of oxidizing the PAS-p is carried out at a pressure between 0.5 and 10 bars, more preferably between 0.8 and 5 bars, even more preferably at atmospheric pressure.

Preferably, said step of oxidizing the PAS-p is carried out under the boiling point of the liquid comprising the oxidizing agent.

Preferably, said step of oxidizing the PAS-p is carried out at a temperature lower than 100° C., more preferably lower than 90° C., even more preferably lower than 80° C. Preferably, said step of oxidizing the PAS-p is carried out at a temperature higher than 10° C., more preferably higher than 30° C., even more preferably higher than 50° C. For example, in the embodiments in which said liquid contains acetic acid, said step of oxidizing the PAS-p is carried out at a temperature of about 70° C.

Preferably, the reaction time of said step of oxidizing ranges from 0.5 to 16 hours, more preferably from 2 to 8 hours, even more preferably from 3 to 4 hours. The choice of the reaction time strongly depends on the reaction temperature and the liquid containing the oxidizing agent. For example, in the embodiment in which said liquid contains acetic acid and hydrogen peroxide as the oxidizing agent, the reaction time is about 3 hours under a temperature of about 70° C.

Polymer Composition (C) and Method for its Manufacturing

As said, the present invention also pertains to a polymer composition (C) comprising the poly(arylene sulfide) (PAS) of formula (I).

Preferably, the PAS is present in the polymer composition (C) in an amount of at least 10 wt. %, more preferably at least 15 wt. %, even more preferably at least 20 wt. %, most preferably at least 25 wt. %, based on the total weight of the polymer composition (C).

Preferably, the PAS is present in the polymer composition (C) in an amount of at most 99 wt. %, more preferably at most 95 wt. %, even more preferably at most 80 wt. %, most preferably at most 60 wt. %, based on the total weight of the polymer composition (C).

According to an embodiment of the invention, the PAS is present in the polymer composition (C) in an amount ranging from 10 to 70 wt. %, preferably from 20 to 60 wt. %, based on the total weight of the polymer composition (C).

As said, the polymer composition (C) comprises up to 65 wt. %, based on the total weight of the polymer composition, of at least one additional component selected from the group consisting of fillers, reinforcing agents, elastomers, colorants, dyes, pigments, lubricants, plasticizers, flame retardants, nucleating agents, heat stabilizers, light stabilizers, antioxidants, processing aids, fusing agents, electromagnetic absorbers and combinations thereof.

The polymer composition may also comprise at least one thermoplastic polymer. The term “thermoplastic” is intended to denote a polymer which softens on heating and hardens on cooling at room temperature, which at room temperature exists below its glass transition temperature if fully amorphous or below its melting point if semi-crystalline. It is nevertheless generally preferred for said polymer to be semi-crystalline, which is to say to have a definite melting point; preferred polymers are those possessing a heat of fusion (ΔH_{f}) of at least 10 J/g, preferably of at least 25 J/g, more preferably of at least 30 J/g, when determined according to ASTM D3418. Without upper limit for heat of fusion being critical, it is nevertheless understood that said polymer will generally possess a heat of fusion of at most 80 J/g, preferably of at most 60 J/g, more preferably of at most 40 J/g. For example, said at least one thermoplastic polymer is selected from poly(arylene sulfides) distinct from the PAS according to the invention, aliphatic, cycloaliphatic and semi-aromatic polyamides, aliphatic, semi-aromatic and aromatic polyesters, polysulfones, aliphatic and aromatic polyketones, polyetherimide, polyamideimide, polycarbonate, fluorinated thermoplastic polymers.

According to an embodiment, the polymer composition (C) comprises the poly(arylene sulfide) (PAS) of formula (I) and at least one poly(phenylene sulfide) (PPS) polymer. For example, the polymer composition (C) may comprise a polymer component consisting of a blend of the PAS of the invention and a PPS polymer, distinct from the PAS on the invention, varying in a broad weight ratio, for example from 10:90 to 90:10 or from 20:80 to 80:20. According to a specific embodiment, the polymer composition comprises: a) a polymer component consisting of 50 wt. % of the PAS of the invention and 50 wt. % of a PPS polymer, distinct from the PAS on the invention, and b) reinforcing agents, for example glass fibers in an amount which is less than 50 wt. % based on the total weight of the polymer composition (C).

According to a preferred embodiment, said polymer composition (C) comprises at least one reinforcing agent, also referred to as reinforcing filler or fiber.

Said at least one reinforcing agent may be selected from the group consisting of fibrous reinforcing fillers, particulate reinforcing fillers and mixtures thereof. A fibrous reinforcing filler is considered herein to be a material having length, width and thickness, wherein the average length is significantly larger than both the width and the thickness. Generally, a fibrous reinforcing filler has an aspect ratio, defined as the average ratio between the length and the largest of the width and the thickness of at least 5, at least 10, at least 20 or at least 50.

Fibrous reinforcing fillers include glass fibers, carbon or graphite fibers, and fibers formed of silicon carbide, alumina, titania, boron and the like, and may include mixtures comprising two or more such fibers. Non-fibrous reinforcing fillers include notably talc, mica, titanium dioxide, calcium carbonate, potassium titanate, silica, kaolin, chalk, alumina, mineral fillers, and the like.

Said at least one reinforcing agent is preferably present in the polymer composition (C) in an amount of at least 10 wt. %, more preferably at least 15 wt. %, even more preferably at least 20 wt. %, most preferably at least 30 wt. %, based on the total weight of the polymer composition (C).

Said at least one reinforcing agent is preferably present in the polymer composition (C) in an amount of at most 65 wt. %, more preferably at most 60 wt. %, even more preferably at most 55 wt. %, most preferably at most 50 wt. %, based on the total weight of the polymer composition (C).

Preferably, said at least one reinforcing agent is a fibrous reinforcing filler. Among fibrous reinforcing fillers, glass fibers and carbon fibers are preferred. According to a preferred embodiment of the invention, said polymer composition (C) comprises from 10 to 60 wt. % of glass fibers and/or carbon fibers.

Another aspect of the present invention concerns a method for manufacturing the polymer composition (C) as above described, said method comprising mixing the poly(arylene sulfide) (PAS) of formula (I) and said at least one additional component.

Said method advantageously comprises mixing the PAS and said at least one additional component by dry blending and/or melt compounding. Said method preferably comprises mixing the PAS and said at least one additional component by melt compounding, notably in continuous or batch devices. Such devices are well known to those skilled in the art.

Examples of suitable continuous devices to melt compound the polymer composition (C) are screw extruders. Preferably, melt compounding is carried out in a twin-screw extruder.

If the polymer composition (C) comprises a reinforcing agent having a long physical shape (e.g. a long glass fiber), drawing extrusion molding may be used to prepare a reinforced composition.

Article and Applications

The present invention also relates to an article, part or composite material comprising the poly(arylene sulfide) (PAS) of formula (I) or the polymer composition (C) described above, and to the use of said article, part or composite material in oil and gas applications, automotive applications, electric and electronic applications, aerospace and consumer goods.

With respect to automotive applications, said articles can be pans (e.g. oil pans), panels (e.g. exterior body panels, including but not limited to quarter panels, trunk, hood; and interior body panels, including but not limited to, door panels and dash panels), side-panels, mirrors, bumpers, bars (e.g., torsion bars and sway bars), rods, suspensions components (e.g., suspension rods, leaf springs, suspension arms), and turbo charger components (e.g. housings, volutes, compressor wheels and impellers), pipes (to convey for example fuel, coolant, air, brake fluid). With respect to oil and gas applications, said articles can be drilling components, such as downhole drilling tubes, chemical injection tubes, undersea umbilicals and hydraulic control lines. Said articles can also be mobile electronic device components.

According to an embodiment, the composite material of the invention is a continuous fibers reinforced thermoplastics composite. The fibers may be composed of carbon, glass or organic fibers such as aramid fibers.

According to an embodiment, the articles of the present invention are molded from the PAS of formula (I) or the polyamide composition (C) of the present invention, by any process adapted to thermoplastics, e.g. extrusion, injection molding, blow molding, rotomolding or compression molding.

According to another embodiment, the articles of the present invention are 3D printed from the PAS of formula (I) or the polymer composition (C) of the invention, by a process comprising a step of extrusion of the material, which is for example in the form of a filament, or by a process comprising a step of laser sintering of the material, which is in this case in the form of a powder.

The PAS of formula (I) or the polymer composition (C) can therefore be in the form of a thread or a filament to be used in a process of 3D printing, e.g. Fused Filament Fabrication, also known as Fused Deposition Modelling (FDM), or in the form of a powder to be used in a process of 3D printing, e.g. Selective Laser Sintering (SLS).

Accordingly, the PAS of formula (I) or the polymer composition (C) of the invention can be advantageously used for 3D printing applications.

The invention will now be described with reference to the following examples, whose purpose is merely illustrative and not intended to limit the scope of the invention.

### EXPERIMENTAL SECTION

Materials

Ryton® QA281N is a poly(phenylene sulfide) commercially available from Solvay Specialty Polymers USA.

Hydrogen peroxide 30% w/w aqueous solution was purchased from Fischer.

Acetic acid with purity of 99% was purchased from VWR.

Methods

DSC/Heat of Fusion

DSC analyses were carried out on DSC Q200-5293 TA Instrument according to ASTM D3418 and data was collected through a two heat, one cool method. The protocol used is the following: 1^{st} heat cycle from 30.00° C. to 350.00° C. at 20.00° C./min; isothermal for 5 minutes; 1^{st} cool cycle from 350.00° C. to 100.00° C. at 20.00° C./min; 2^{nd} heat cycle from 100.00° C. to 350.00° C. at 20.00° C./min. The melting temperature (Tₘ) is recorded during the 2^{nd} heat cycle and the melt crystallization temperature (T_{mc}) is recorded during the cool cycle.

GPC

Mn and Mw were determined by gel permeation chromatography (GPC) at 210° C. using a PL 220 high temperature GPC with a 1-chloronaphtalene mobile phase.

Melt Flow Index

The melt flow index was determined according to ASTM D1238 at 315.6° C. with a 1.27 kg weight.

Mechanical Testing

Test specimens were injection molded into Type V tensile bars according to ASTM D3641, using a barrel temperature set at Tm+30° C. in a mold regulated at 130° C. Mechanical tests were performed on injection molded test specimens with a gauge length of 0.3 inch using the Instron 5569 machine and according to ASTM D638 at 23.2° C. with 54.7% humidity.

### SYNTHESIS EXAMPLES

### Example 1 (Ex. 1)

Ryton® QA281N (200 g, 1.0 eq) was suspended in acetic acid (400 mL) under a nitrogen atmosphere inside a 1 L reactor equipped with an inclined quadripale type stirrer, a condenser, a double jacket for heating and a syringe pump.

The resulting suspension was stirred at room temperature and hydrogen peroxide 30% w/w (6.0 g, 0.03 eq) was added via syringe pump over a period of 15 minutes.

The temperature was raised to 70° C. (double jacket set at 75° C.) and the reaction mixture was stirred for 3 hours at this temperature. The stirring speed was set to 300 rpm. Then, an analysis of the supernatant with Quantofix peroxide test sticks confirmed the absence of peroxide.

The reaction mixture was then cooled to room temperature and filtered. The recovered solids were washed twice with acetic acid at room temperature (2×100 mL). The solids were then dried in a rotating evaporator under a pressure of 20 mbar and at a temperature of 50° C. for 2 hours. The recovered solids were than dried under vacuum (˜20 mbar) at 120° C. for 7 hours.

The obtained product is a poly(phenylene sulfide) of formula (I), wherein j=0, nₚ=97%, n_{q}+nᵣ=3%. Accordingly, under these conditions 3 mol. % of the sulfide moieties of Ryton® QA281N have been oxidized into sulfoxide and sulfone moieties.

### Example 2 (Ex. 2)

Ryton® QA281N (200 g, 1.0 eq) was suspended in acetic acid (400 mL) under a nitrogen atmosphere inside a 1 L reactor equipped with an inclined quadripale type stirrer, a condenser, a double jacket for heating and a syringe pump.

The resulting suspension was stirred at room temperature and hydrogen peroxide 30% w/w (10.0 g, 0.05 eq) was added via syringe pump over a period of 15 minutes.

The temperature was raised to 70° C. (double jacket set at 75° C.) and the reaction mixture was stirred for 3 hours at this temperature. The stirring speed was set to 300 rpm. Then, an analysis of the supernatant with Quantofix peroxide test sticks confirmed the absence of peroxide.

The reaction mixture was then cooled to room temperature and filtered. The recovered solids were washed twice with acetic acid at room temperature (2×100 mL). The solids were then dried in a rotating evaporator under a pressure of 20 mbar and at a temperature of 50° C. for 2 hours. The recovered solids were than dried under vacuum (˜20 mbar) at 120° C. for 7 hours.

The so obtained product is a poly(phenylene sulfide) of formula (I), wherein j=0, nₚ=95%, n_{q}+nᵣ=5%. Accordingly, under these conditions 5 mol. % of the sulfide moieties of Ryton® QA281N have been oxidized into sulfoxide and sulfone moieties.

### Comparative Example (Ex. 3C)

Ryton® QA281N (200 g, 1.0 eq) was suspended in acetic acid (400 mL) under a nitrogen atmosphere inside a 1 L reactor equipped with an inclined quadripale type stirrer, a condenser, a double jacket for heating and a syringe pump.

The resulting suspension was stirred at room temperature and hydrogen peroxide 30% w/w (20.0 g, 0.1 eq) was added via syringe pump over a period of 15 minutes.

The temperature was raised to 70° C. (double jacket set at 75° C.) and the reaction mixture was stirred for 3 hours at this temperature. The stirring speed was set to 300 rpm. Then, an analysis of the supernatant with Quantofix peroxide test sticks confirmed the absence of peroxide.

The reaction mixture was then cooled to room temperature and filtered. The recovered solids were washed twice with acetic acid at room temperature (2×100 mL). The solids were then dried in a rotating evaporator under a pressure of 20 mbar and at a temperature of 50° C. for 2 hours. The recovered solids were than dried under vacuum (˜20 mbar) at 120° C. for 7 hours.

The so obtained product is a poly(phenylene sulfide) of formula 1, wherein j=0, nₚ=90%, n_{q}+nᵣ=10%. Accordingly, under these conditions 10 mol. % of the sulfide moieties of Ryton® QA281N have been oxidized into sulfoxide and sulfone moieties.

Results

Table 1 shows the DSC values obtained for the poly(phenylene sulfides) synthesized according to Ex. 1 and Ex. 2. Said values are compared to those of Ryton® QA281N and the poly(phenylene sulfide) synthesized according to Ex. 3C.

TABLE 1

| | Oxidized | | | | |
|---|---|---|---|---|---|
| | moieties | T_{g} | T_{mc} | Tₘ | ΔH |
| | [mol. %] | [° C.] | [° C.] | [° C.] | [J · g⁻¹] |
| Ryton ® | 0 | 92.9 | 231.6 | 282.5 | 93.3 |
| QA281N | | | | | |
| Ex.1 | 3 | 95.7 | 224.8 | 275.4 | 63.8 |
| Ex.2 | 5 | 97.9 | 203.5 | 268.9 | 59.9 |
| Ex.3C | 10 | 101.9 | — | 251.7 | 15.9 |

As evident from Table 1, the glass transition temperature (T_{g}) value increases with the mol. % increase of the oxidized moieties. In other words, the T_{g} value increases along with the oxidation state of the poly(phenylene sulfide). On the contrary, the melting temperature (Tₘ) and the melt crystallization temperature (T_{mc}) decrease with the mol. % increase of the oxidized moieties. No melt crystallization temperature upon cooling was detected for the poly(phenylene sulfide) according to Ex. 3C.

As evident from Table 1, the heat of fusion (ΔH) and, therefore, the crystallinity of the poly(phenylene sulfides) synthesized according to Ex. 1, Ex. 2 and Ex. 3C are lower than of Ryton® QA281N.

Table 2 shows the number average molecular weight (Mn) and the weight average molecular weight (Mw) of Ryton® QA281N and of the poly(phenylene sulfides) synthesized according to Ex. 1, Ex. 2 and Ex. 3C.

TABLE 2

| | Oxidized moieties | Mn | Mw |
|---|---|---|---|
| | [mol. %] | (g/mol) | (g/mol) |
| Ryton ® QA281N | 0 | 14280 | 36200 |
| Ex.1 | 3 | 17810 | 42180 |
| Ex.2 | 5 | 18250 | 42670 |
| Ex.3C | 10 | 16610 | 40810 |

As evident from Table 2, the Mw increases with the mol. % increase of the oxidized moieties compared to Ryton® QA281N, but remains consistent for the poly(phenylene sulfides) of Ex. 1, Ex. 2 and Ex. 3C.

Table 3 shows the melt flow index of the poly(phenylene sulfides) synthesized according to Ex. 1 and Ex. 2 in comparison with those of Ryton® QA281N and the poly(phenylene sulfide) synthesized according to Ex. 3C.

TABLE 3

| | Oxidized moieties | Melt flow index |
|---|---|---|
| | [mol. %] | (g/10 min) |
| Ryton ® QA281N | 0 | 40 |
| Ex.1 | 3 | 17 |
| Ex.2 | 5 | 2 |
| Ex.3C | 10 | N/A |

Interestingly and surprisingly, as evident from Table 3, there is a steady decrease of the melt flow index with the mol. % increase of the oxidized moieties and, accordingly, a steady increase of the viscosity along with the mol. % of the oxidized moieties. As a result, the poly(phenylene sulfides) of Ex. 1 and Ex. 2 can be advantageously used for extrusion molding applications. On the contrary, the viscosity of Ryton® QA281N is not sufficiently high for such applications, and the viscosity of the poly(phenylene sulfide) of Ex. 3 appears to be too high so that the polymer degraded during the experiment.

Table 4 reports the mechanical properties of the poly(phenylene sulfides) of Ex. 1 and Ex. 2 in comparison with those of Ryton® QA281N and the poly(phenylene sulfide) of Ex. 3C. The poly(phenylene sulfides) of Ex. 1 and Ex. 2 had similar molding ability to the reference polymer Ryton® QA281N. The poly(phenylene sulfide) of Ex. 3C was more challenging to mold.

TABLE 4

| | Oxidized | Stress at | Tensile | Modulus of |
|---|---|---|---|---|
| | moieties | break | elongation | elasticity |
| | [mol. %] | [MPa] | [%] | [GPa] |
| Ryton ® QA281N | 0 | 87 | 4.4 | 3.61 |
| Ex.1 (tensile bar) | 3 | 83 | 5.1 | 3.32 |
| Ex.2 (tensile bar) | 5 | 70 | 7.2 | 3.55 |
| Ex.3C (tensile bar) | 10 | 59 | 3.2 | 3.34 |

The data reported in Table 4 show that the tensile stress at break and the modulus of elasticity of the bars according to Ex. 1 and Ex. 2 are not significantly decreased when compared to Ryton® QA281N. This means that the poly(phenylene sulfides) according to Ex. 1 and Ex. 2 have tensile strength properties similar to those of Ryton® QA281N. On the contrary, the bar according to Ex. 3C has lower tensile stress at break and, therefore, a lower tensile strength than Ryton® QA281N and the poly(phenylene sulfides) of Ex. 1 and Ex. 2 according to the present invention.

Table 4 also shows that the bars according to Ex. 1 and Ex. 2 have higher tensile elongation than Ryton® QA281N, which means that the poly(phenylene sulfides) of Ex. 1 and Ex. 2 have a higher elongation at break and a higher impact resistance, namely they are more ductile and tougher than Ryton® QA281N. Surprisingly, the bar according to Ex. 3C has a lower elongation at break than both the Ryton® QA281N and the bars of Ex. 1 and Ex. 2 according to the present invention.

Therefore, as evident from Table 4, the poly(phenylene sulfides) according to Ex. 1 and Ex. 2, having an oxidation between 2 and 9 mol. %, show an improved balance between tensile stress at break, modulus of elasticity and tensile elongation, namely an improved balance between ductility, toughness and tensile strength. Said properties make the poly(phenylene sulfides) according to the invention suitable for different applications including injection molded articles, extrusion molded articles, 3D printed articles and thermoplastic composites. On the contrary, Ryton® QA281N shows very low tensile elongation and the poly(phenylene sulfide) according to Ex. 3C shows both very low tensile stress at break and very low elongation at break.

1-15. (canceled)

16. A poly(arylene sulfide) (PAS), comprising recurring units p, q and r according of formula (I): 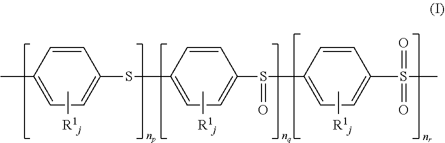
nₚ, n_{q} and nᵣ are respectively the mole % of each recurring units p, q and r;
recurring units p, q and r are arranged in blocks, in alternation or randomly;
2%≤(n_{q}+nᵣ)/(nₚ+n_{q}+nᵣ)≤9%; n_{q} is ≤0% and nᵣ is ≤0%;
j is zero or an integer varying between 1 and 4;
R¹ is selected from the group consisting of halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups,
wherein the PAS has a heat of fusion of more than 20 J/g, determined on the 2^{nd} heat scan in differential scanning calorimeter (DSC) according to ASTM D3418, using heating and cooling rates of 20° C./min.

17. The PAS according to claim 16, wherein nₚ+n_{q}+n_{r≤}50%.

18. The PAS according to claim 16, consisting essentially of recurring units p, and recurring units q and/or r.

19. The PAS according to claim 16, wherein j is zero in formula (I).

20. The PAS according to claim 16, having a melt flow rate MFR (at 315.6° C. under a weight of 1.27 kg according to ASTM D1238, procedure B) of at most 700 g/10 min and/or of at least 1 g/10 min.

21. The PAS according to claim 16, having a melting point of at most 280° C. and/or of at least 252° C., when determined on the 2^{nd} heat scan in differential scanning calorimeter (DSC) according to ASTM D3418, using heating and cooling rates of 20° C./min.

22. A process for manufacturing the poly(arylene sulfide) (PAS) of formula (I) according to claim 16, comprising a step of oxidizing solid particles of a poly(arylene sulfide) (PAS-p) comprising recurring units p according to formula (VII): 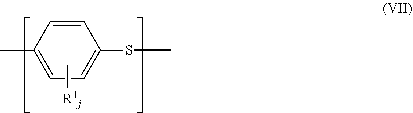
j is zero or an integer varying between 1 and 4;
R¹ is selected from the group consisting of halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups,
wherein said step of oxidation takes place in a liquid containing an oxidizing agent.

23. The process according to claim 22, wherein said liquid contains acetic acid.

24. The process according to claim 22, wherein said oxidizing agent is hydrogen peroxide.

25. The process according to claim 22, wherein the step of oxidizing the PAS-p is carried out at a temperature lower than 100° C. and/or higher than 10° C.

26. A polymer composition (C), comprising:
the poly(arylene sulfide) (PAS) of formula (I) according to claim 16,
up to 65 wt. %, based on the total weight of the polymer composition, of at least one additional component selected from the group consisting of fillers, reinforcing agents, elastomers, colorants, dyes, pigments, lubricants, plasticizers, flame retardants, nucleating agents, heat stabilizers, light stabilizers, antioxidants, processing aids, fusing agents, electomagnetic absorbers and combinations thereof.

27. The polymer composition (C) according to claim 26, comprising from 10 to 60 wt. % of glass fibers and/or carbon fibers.

28. A method for manufacturing the composition (C) according to claim 26, comprising mixing said poly(arylene sulfide) (PAS) of formula (I) and said at least one additional component.

29. An article, part or composite material comprising the poly(arylene sulfide) (PAS) of formula (I) according to claim 16.

30. A method for using the article, part or composite material of claim 29, the method comprising using the article part or composite material in oil and gas applications, automotive applications, electric and electronic applications, aerospace and consumer goods.
